(19) United States
(12) Patent Application Publication
(10) Pub. No.: US 2005/0125830 A1
(43) Pub. Date: Jun. 9, 2005

(54) Methods and apparatuses for transmitting data in a television broadcast

(76) Inventors: Mikko Halttunen, Oulu (FI); Marko Leinonen, Oulu (FI)

Correspondence Address: CRAWFORD MAUNU PLLC, 1270 NORTHLAND DRIVE, SUITE 390, ST. PAUL, MN, 55120, US

(21) Appl. No.: 10/726,915

(22) Filed: Dec. 3, 2003

(51) Int. Cl. H04N 7/173; H04N 7/18; H04N 7/20; H04N 7/16

(52) U.S. Cl. 725/81; 725/62; 725/63; 725/100

(57) ABSTRACT

Methods and apparatuses for transmitting data in a television broadcast, such as: a method and an arrangement for transmitting data to a terminal of a radio system, a method and a system for providing interactive television, a method for running a network game, a network game server, a local game server, and a game terminal. The arrangement for transmitting data to a terminal of a radio system includes a receiver configured to receive a television broadcast, a processing unit configured to separate data from the received television broadcast, and a transmitter configured to transmit the separated data through a wireless connection to the terminal.

### FIELD

The invention relates to an arrangement for transmitting data to a terminal of a radio system, a method for transmitting data to a terminal of a radio system, a method for providing interactive television, an interactive television system, a method for running a network game, a network game server, a local game server, and a game terminal.

### BACKGROUND

The use of wireless terminals has radically spread. Cellular radio networks utilize valuable radio frequencies, valuable in the sense that the radio frequencies are a limited resource. Besides conventional cellular radio systems, new radio systems, utilizing WLAN (Wireless Local Area Network) technology, for example, are emerging. Although the cell size is usually quite small in WLAN systems, it is important to. use radio resources as effectively as possible there as well because one aim of the WLAN technology is to provide service with very high bit rates at a reasonable cost. The optimization of the use of radio resources is therefore an important research topic with regard to all radio communication systems.

### BRIEF DESCRIPTION OF THE INVENTION

The present invention seeks to provide improved methods and apparatuses for data transmission in a television broadcast.

According to an aspect of the present invention, there is provided an arrangement for transmitting data to a terminal of a radio system, the arrangement comprising: a receiver configured to receive a television broadcast; a processing unit configured to separate data from the received television broadcast; and a transmitter configured to transmit the separated data through a wireless connection to the terminal.

According to another aspect of the present invention, there is provided an arrangement for transmitting data to a terminal of a radio system, the arrangement comprising: receiving means for receiving a television broadcast; processing means for separating data from the received television broadcast; and transmitting means for transmitting the separated data wirelessly to the terminal.

According to another aspect of the present invention, there is provided a method for transmitting data to a terminal of a radio system, the method comprising: embedding data in a television broadcast; transferring the television broadcast to a receiver; separating data from the received television broadcast by the receiver; and transferring the separated data wirelessly from the receiver to a terminal.

According to another aspect of the present invention, there is provided a method for providing interactive television, the method comprising: processing data in a network server; embedding the data in a television broadcast; receiving the television broadcast in a receiver; separating data from the received television broadcast in the receiver; transmitting the data wirelessly from the receiver to a terminal; issuing response data by the terminal; transmitting the response data from the terminal to the network server through a radio system; and processing the response data in the network server.

According to another aspect of the present invention, there is provided an interactive television system comprising: a network server, including a processing unit configured to process data, and to embed the data in a television broadcast; a receiver configured to receive the television broadcast; a second processing unit configured to separate data from the received television broadcast; a transmitter configured to transmit the data wirelessly to a terminal; a terminal including a second receiver configured to receive the data, a user interface configured to issue response data, and a transmitter configured to transmit the response data to the network server through a radio system; process the response data.

According to another aspect of the present invention, there is provided a method for running a network game, the method comprising: processing game data in a network game server; embedding game data in a television broadcast; receiving the television broadcast in a local game server; separating. the game data from the received television broadcast in the local game server; transmitting the game data wirelessly from the local game server to a game terminal; issuing game commands by the game terminal; transmitting game commands from the game terminal to the network game server through a radio system; and updating the game data on the basis of the received game commands in the network game server.

According to another aspect of the present invention, there is provided a network game server comprising: a processing unit configured to process game data; a first communication interface configured to communicate with a television broadcast system; a second communication interface configured to communicate with a radio system; wherein the processing unit is further configured to transmit game data via the first communication interface to the television broadcast system to embed the game data in a television broadcast, to receive game commands from individual players via the second communication interface from game terminals communicating with the radio system, and to update the game data on the basis of the received game commands.

According to another aspect of the present invention, there is provided a local game server comprising: a receiver configured to receive a television broadcast; a processing unit configured to separate game data from the received television broadcast, and to process the game data; and a display interface configured to communicate display information on the game to a display; a communication interface configured to communicate the game data wirelessly to a game terminal.

According to another aspect of the present invention, there is provided a game terminal comprising: game controls configured to issue game commands; a first communication interface configured to receive game data wirelessly from a local game server; a second communication interface configured to communicate wirelessly with a radio system; and a processing unit configured to process the received game data and the issued game commands, and to transmit the issued game commands to a network game server via the second communication interface.

The invention provides several advantages. The invention utilizes both existing and emerging television broadcast systems for transferring data to a terminal of a radio system. The solution saves valuable radio resources of the radio system, such as cellular radio networks, WLAN systems and other radio communication systems. This is because some of the data may be transferred by the television broadcast system near to the terminal, and then short-range radio transmitters or other wireless communication techniques, such as infrared communication, may realize the last communication link between a television broadcast receiver and the terminal. Such communication technologies, as compared with the use of cellular radio network technology, may be priced very competitively, or they may even be free of charge. The use of valuable radio resources can then be optimized for other purposes. Some presented embodiments use radio resources for implementing a return communication channel. Some embodiments provide for interactive television or network gaming.

### LIST OF DRAWINGS

In the following, the invention will be described in greater detail with reference to the preferred embodiments and the accompanying drawings, in which

FIG. 1 is a block diagram illustrating the basic structures necessary for transmitting data in a television broadcast to a terminal of a radio system;

FIGS. 2, 3, 4, 5, 6 and 7 illustrate various embodiments of the basic structures presented in FIG. 1;

FIG. 8 is a flow diagram illustrating a method for transmitting data to a terminal of a radio system;

FIG. 9 illustrates a method for providing interactive television;

FIG. 10 illustrates an interactive television system;

FIG. 11 illustrates a method for running a network game;

FIG. 12 illustrates components of a network game system: a network game server, a local game server and a game terminal; and

FIG. 13 illustrates an exemplary implementation of a television set and a terminal.

### DESCRIPTION OF EMBODIMENTS

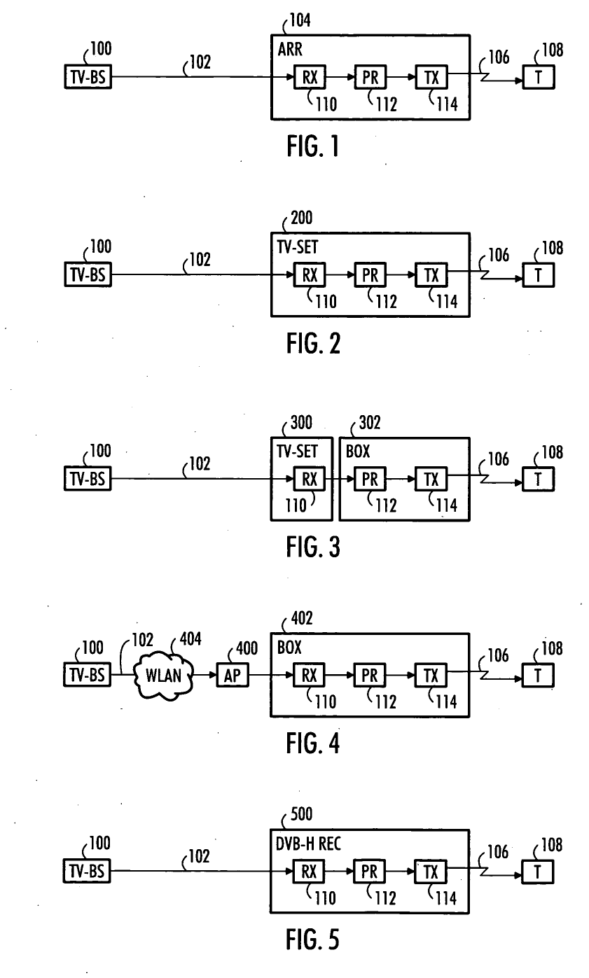

With reference to FIG. 1, examine an example of a system whereto the embodiments of the invention can be applied. A television broadcasting system 100 is used for transmitting a television broadcast. Basically, any known television broadcast system, either analogue or digital, may be used. Examples of digital television broadcasting include the Digital Video Broadcasting Project (DVB). DVB is an industry-led consortium designing global standards for the global delivery of digital television and data services. DVB standards are available from ETSI (European Telecommunications Standards Institute). More information on DVB and the related standards can be found on the websites of DVB and ETSI: currently at the addresses www.dvb.org and www.etsi.org.

The television broadcast system 100 may utilize various transmission technologies for a television broadcast 102. DVB, for example, defines the following technologies: DVB-S, which is a satellite transmission standard based on QPSK (Quadrature Phase Shift Keying); DVB-C, which is a cable delivery mechanism closely related to DVB-S and based around 64-QAM (Quadrature Amplitude Modulation); and DVB-T, which is a terrestrial transmission standard based on COFDM (Coded Orthogonal Frequency Divisional Multiplexing) and QPSK, 16 QAM and 64 QAM modulation. There is also an emerging standard called DVB-H, which is based on DVB-T standard, but as it is aimed at hand-held terminals it uses less power in the receiver than in the DVB-T standard. DVB-H enables the terminal to receive digital television broadcasting over a digital television network without using cellular radio networks at all.

An arrangement 104 for transmitting data to a terminal 108 of a radio system comprises a receiver 110 configured to receive a television broadcast 102, a processing unit 112 configured to separate data from the received television broadcast 102, and a transmitter 114 configured to transmit the separated data through a wireless connection 106 to the terminal 108.

The separated data is data that is useful for the terminal 108. The separated data may be an application, a game, a part of a game, a wallpaper for a display, an upgrade to software, an application for participating in a television show or competition, a picture, a message, a command, or some other data item usable by the terminal 108.

In an embodiment, the data is embedded in a digital television transmission or analogue television transmission. In another embodiment, the data is embedded in a text television transmission. Thus, the separated data can be located in a special page of the text television area, and it may be opened with a command received from the terminal 108, and then the separated data may be downloaded into the terminal 108.

In an embodiment, the processing unit 112 is further configured, for separating data, to capture a screen shot from the received television broadcast 102. In this embodiment, the data has not knowingly beforehand been embedded in the television broadcast 102. Picture the following use case: A user is watching a travel program on television. In the program, the monument of Taj Mahal is shown. The user realizes that s/he wants Taj Mahal as wallpaper to a display of her/his terminal. S/he then sends a command from the terminal 108 to the processing unit 112, ordering the processing unit 112 to capture the image of Taj Mahal from a screen shot of the travel program. The processing unit 112 may further be configured-to modify the size of the captured image to fit the size of the display of the terminal 108. The image is then transferred to the terminal 108. The captured screen shot may also be a screen shot of a game, whereby the screen shot may be used as a part of the game also in the future, after the screen shot has been downloaded into the terminal 108 and stored therein.

In an embodiment illustrated in FIG. 2, the receiver 110, the processing unit 112 and the transmitter 114 are all integrated into a television set 200.

In another embodiment illustrated in FIG. 3, the receiver 110 is integrated into a television set 300, and the processing unit 112 and the transmitter 114 are integrated into a separate box 302 coupleable to the television set 300.

In another embodiment illustrated in FIG. 4, the arrangement 104 is integrated into a separate box 402 coupleable to a Wireless Local Area Network (WLAN) 402 access point 400. WLAN may be as defined by standards in 802.11 series of the IEEE (The Institute of Electrical and Electronics Engineers, Inc.), for example. The access point, or service access point as it is also known, forms an access zone. An access zone is also known as a hotspot. It is an area, such as an office, a university campus, a hotel or an airport, for example, where fast LAN-connections are offered to the users. Access to the Internet may be realized through the access point 400. As illustrated in FIG. 4, the television broadcast 102 is received by the WLAN network and further conveyed to the access point 400 from where it can be wirelessly transmitted to the receiver 110. The box 402 could be integrated into a television set.

In another embodiment illustrated in FIG. 5, the arrangement 104 is integrated into a Digital Video Broadcasting Handheld (DVB-H) receiver 500.

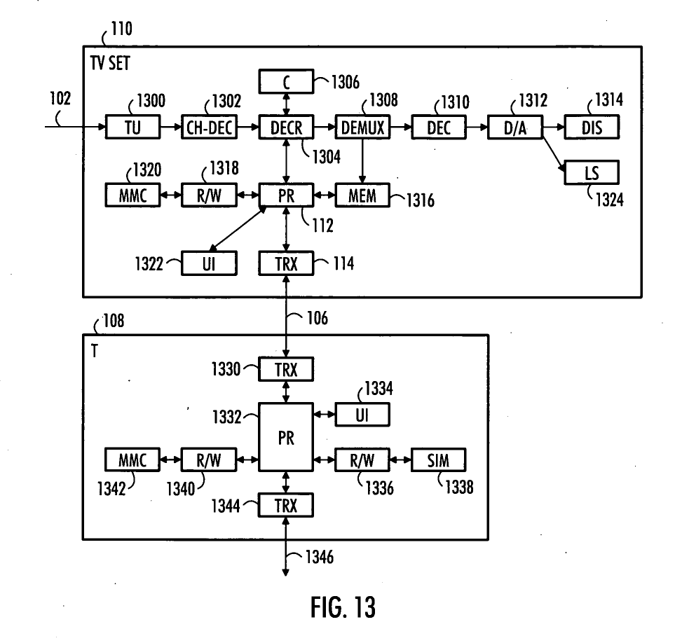

As the wide variety of embodiments illustrated in FIGS. 1 to 5 proves, the arrangement 104 can be implemented on many platforms. Let us next, with reference to FIG. 13, illustrate an exemplary implementation of a television set 110 and a terminal 108. Please note that reference numeral 110 is now used for referring to a television set instead of a mere receiver, because in this embodiment the rest of the parts of the arrangement 104, namely the processing unit 112 and the transmitter 114, are integrated into the television set 110, which also implements the functionality of the receiver.

The television set 110 comprises a tuner 1300 for selecting a channel from broadcast, transforming the selected channel into base band or intermediate frequency, and demodulating a signal of the selected channel. The demodulated signal is then fed into a channel decoder 1302, which digitalizes the signal and performs the necessary error correction. Next, the error corrected bit stream is fed into a decryption module 1304, which decrypts the bit stream if it has been encrypted. The encryption module 1304 may need a smart card 1306, i.e. a module with an embedded integrated circuit, which provides a secure medium for storing encryption keys and algorithms, for example. Such a smart card 1306 may have to be purchased from the television broadcasting company.

The bit stream, possibly decrypted, is then fed into a multiplexer 1308, which separates the audio, video and data packets into streams of their own. Audio and video packets are fed into audio and video decoders 1310. A video decoder may be an MPEG-2 (Moving Picture Experts Group) decoder, for example. The decoded audio and video streams may have to be digital-to-analogue (D/A) converted in a D/A-converter 1312 before being fed into a display 1314 and a loudspeaker 1324.

The separated data packets are transferred from a multiplexer 1316 into a memory. The processing unit 112 then separates data from the data packets, and using a transmitter 114, transmits the separated data through a wireless connection 106 to the receiver 1330 of the terminal 108.

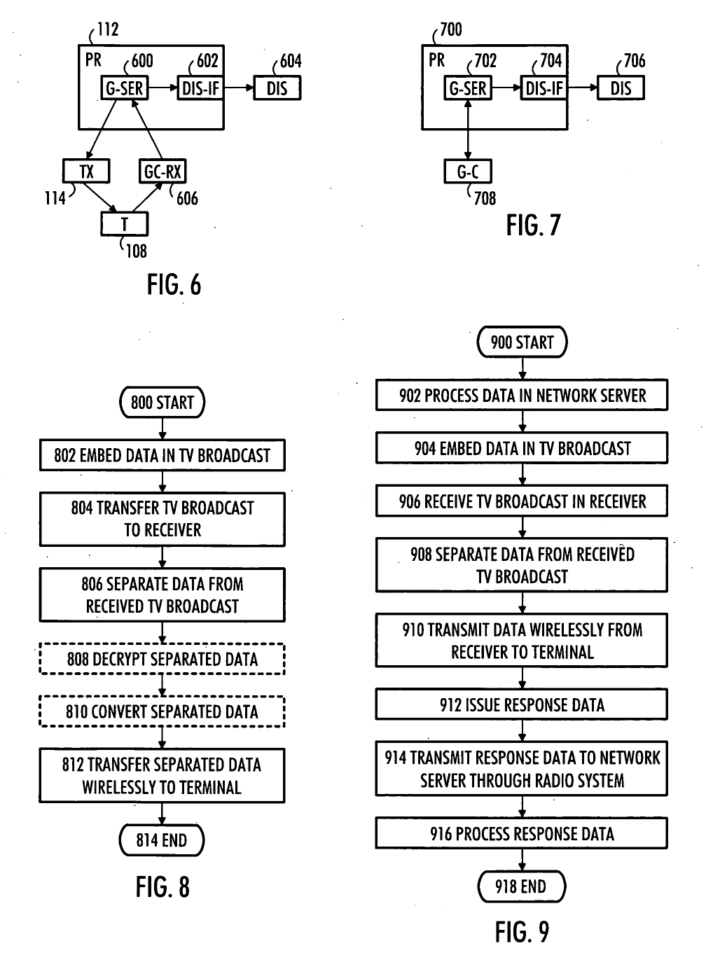

In an embodiment illustrated in FIG. 6, the arrangement further comprises a game server 600 configured to run a game, and a display interface 602 configured to communicate display information on the game to a display 604. A game refers to electronic entertainment games. The term ‘video game’ may also be used. FIG. 6 also illustrates an embodiment wherein the arrangement further comprises a game control receiver 606 configured to receive game commands from the terminal 108. The game control receiver 606 and the transmitter 114 may be integrated into a transceiver. In the embodiment of FIG. 6, the game runs in the processor 112 that is not located in the terminal 108, and game control commands are received from the terminal 108 over a wireless connection. In the embodiment of FIG. 7, the game runs in the processor 700 of the terminal 108. Therefore, game controls 708 are coupled to a game server 702 running in the processor 700, and a display interface 704 coupled to the game server 702 couples the terminal 108 to a display 706. The display 706 may be a display of the terminal 108, or it may also be a separate wider screen.

In an embodiment of FIG. 13, both the transmitter 114 and the receiver 1330 are actually transceivers, as bi-directional communication may be necessary between the television set 110 and the terminal 108 to implement control functions for the transfer, for example.

Both the transmitter 114 and the receiver 1330 may use any known wireless transmission technologies. Transmission technologies include wireless radio connection technologies, such as WLAN and Bluetooth™, and infrared technologies, but the embodiments are not limited to these technologies only. Bluetooth™ technology uses a radio link covering at most a few hundred meters on a frequency of 2.4 gigahertz. Infrared communication technologies include an IrDA (the Infrared Data Association) standard.

In an embodiment, the processing unit 112 is further configured to convert the separated data into a format suitable for the terminal 108. The separated data may be compressed, for example, and it has to be decompressed before the terminal 108 is able house it. Naturally, the terminal 108 may also perform the decompression. Another example of conversion is such that an application located in the separated data is converted to match the user interface style of the terminal 108.

The television set 110 may include a read/write unit 1318 capable of performing read/write data operations with a Multimedia Memory Card (MMC) 1320. The separated data may be written into the MMC 1320.

In an embodiment, the separated data comprises encrypted data, and the processing unit 112 is further configured to decrypt the separated data. Thus, the separated data may be encrypted twice, i.e. a television broadcast as a whole may be encrypted, and also the separated data may be encrypted with another encryption scheme. It is also possible that only the separated data is encrypted. The decryption of the separated data may be performed in the processing unit 112 with the aid of the decryption module 1304, and possibly also with the aid of the smart card 1306. The decryption may require the user to provide a code by means of a user interface 1322 of the television set. The user may acquire the required code from the television broadcasting company or some service provider that utilizes the described arrangement for transmitting its data to the end-customer's terminal.

The terminal 108 communicates with a radio system. The radio system may be a cellular radio network, such as GSM (Global System for Mobile Communications), GPRS (General Packet Radio System) or UMTS (Universal Mobile Telecommunications System). Naturally, these systems are only examples and the terminal 108 can be a terminal of various other radio systems as well, a terminal of the CDMA (Code Division Multiple Access) based radio system or a terminal of the above-mentioned WLAN system, for example. The radio system may also use any other radio access technology known in the art. Besides the transceiver 1330 explained above, the terminal 108 also includes another transceiver 1344 for implementing a radio connection 1346 with the radio system.

Both transceivers 1330, 1344 of the terminal 108 are coupled to a processing unit 1332. If the terminal 108 is a subscriber terminal of the radio system, it may include a read/write unit 1336 where a SIM (Subscriber Identity Module) 1338 may be placed. The terminal 108 may also comprise another read/write unit 1340 that may accommodate an MMC 1342. The MMC 1342 may be used for storing the downloaded separated data. The MMC 1342 may already include a game, and the downloaded separated data may add a new functionality to the game, such as new game fields or other features present in modern video games. The terminal 108 also includes a user interface 1334.

It is well understood by the skilled person that a contemporary television set 110 and a terminal 108 also include numerous other structures, but as they are not necessary for illustrating the embodiments, they are not further described herein.

Next, with reference to FIG. 8, a method for transmitting data to a terminal of a radio system is explained. The method starts in 800. Data is embedded in a television broadcast in 802. The television broadcast is then transferred to a receiver in 804. The receiver then separates data from the received television broadcast in 806.

In an embodiment, a screen shot is captured from the received television broadcast for separating data.

In an embodiment, the separated data is decrypted in 808, because the separated data comprises encrypted data.

In an embodiment, the separated data is converted into a format suitable for the terminal in 810.

Finally, the separated data is transferred wirelessly from the receiver to a terminal in 812.

In an embodiment, a game is run in the terminal, and the separated data is inputted as input to the game.

The method ends in 814. The arrangement described above may be used for implementing the method, but the method may also be applied to other systems where data may be transmitted in a television broadcast.

Next, with reference to FIG. 9, a method for providing interactive television is explained. The method starts in 900. Data is processed in a network server in 902. Next, the data is embedded in a television broadcast in 904. The television broadcast is received in a receiver in 906. Data is separated from the received television broadcast in the receiver in 908. Next, the data is transmitted wirelessly from the receiver to a terminal in 910. The terminal issues response data in 912. In an embodiment, the separated data may include an application for participating in a television show or competition. The response data may be a message or a command, for example.

The response data is transmitted from the terminal to the network server through a radio system in 914. The response data is processed in the network server in 916. If the response data is an answer to a competition, the network server may check the answer, for example. The method may be used for implementing any interactive television where data may be embedded in the television broadcast. The method is ended in 918. The method may be implemented with an interactive television system explained next, but the method may also be applied to other interactive television systems as well.

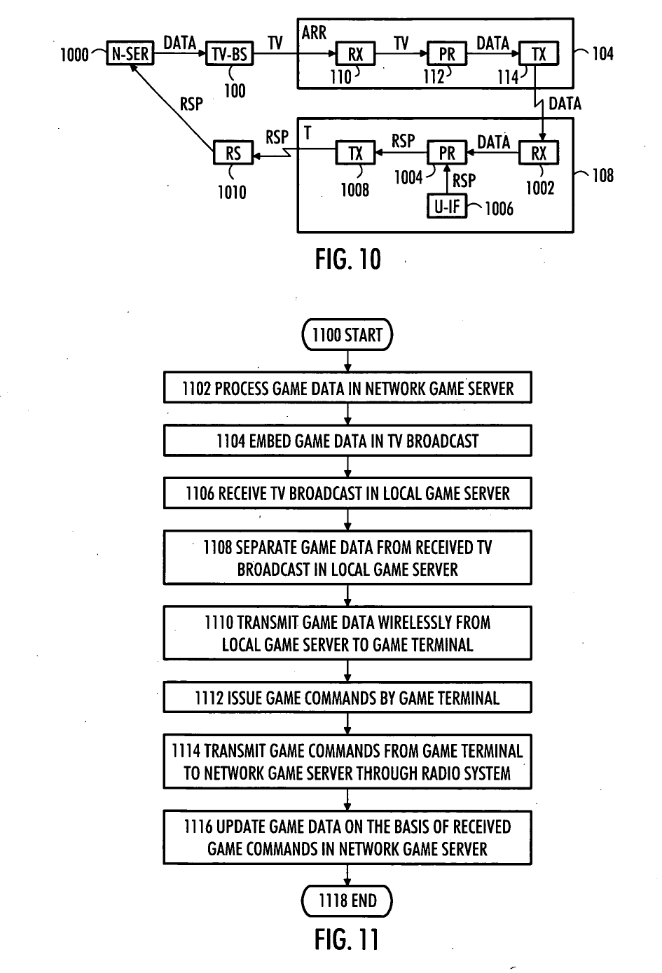

With reference to FIG. 10, let us examine an interactive television system. A network server 1000 includes a processing unit (not shown) configured to process data and embed the data in a television broadcast. The data may be embedded such that the network server 1000 transfers the data into a television broadcast system 100. A service provider separate from the television broadcasting company may thus operate the network server 1000, but the network server 1000 may also be a part of the television broadcast system. Either way, the service provider may be a separate company or the television broadcasting company.

The arrangement 104 explained above is then used for receiving the television broadcast. The arrangement 104 includes the receiver 110 configured to receive the television broadcast, the processing unit 112 configured to separate data from the received television broadcast, and the transmitter 114 configured to transmit the data wirelessly to a terminal 108.

The terminal 108 may also be of the type presented above. The terminal 108 includes a receiver 1002 configured to receive data, a user interface 1006 configured to issue response data, and a transmitter 1008 configured to transmit the response data to the network server 1000 through a radio system 1010. The terminal 108 may also include a processing unit 1004 configured to process the data received from the network server 1000 and the response data issued by the user of the terminal 108 by means of the user interface 1006.

The network server 1000 thus includes a network interface (not shown) capable of receiving the response data from the radio system 1010. The processing unit of the network server 1000 is further configured to process the response data.

As already explained above, the arrangement for transmitting data to a terminal of a radio system may also be used for gaming purposes. FIG. 11 illustrates a method for running a network game. The method starts in 1100. Game data is processed in a network game server in 1102. The game data is embedded in a television broadcast in 1104. The television broadcast is received in a local game server in 1106. The game data is separated from the received television broadcast in a local game server in 1108. The game data is transmitted wirelessly from the local game server to a game terminal in 1110. The game terminal issues game commands in 1112. The game commands are transmitted from the game terminal to the network game server through a radio system in 1114. The game data is updated on the basis of the received game commands in the network game server in 1116. This method forms an ongoing process, where operations 1102 to 1116 are repeated as long as the network game is running. If the network game is ended, the method ends in 1118. In the following, a system for network gaming that can be used for implementing the method is explained. Besides this, also other gaming environments may be used for implementing the method.

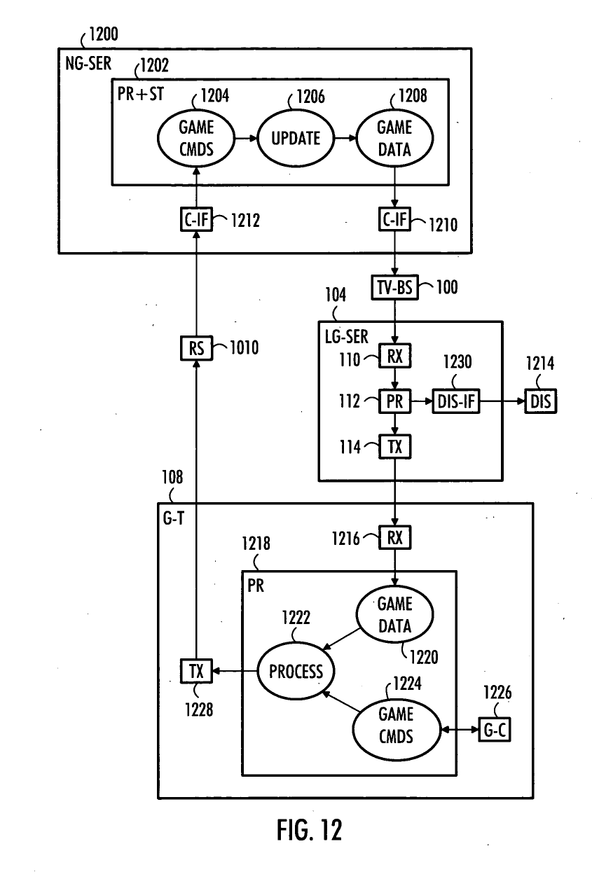

FIG. 12 illustrates the components of the network game system: a network game server, a local game server and a game terminal.

A network game server 1200 includes a processing unit 1202 configured to process game data 1208. The network game server 1200 also includes two communication interfaces: a first communication interface 1210 configured to communicate with the television broadcast system 100, and a second communication interface 1212 configured to communicate with the radio system 1010. The processing unit 1202 is further configured to transmit the game data 1208 via the first communication interface 1210 to the television broadcast system 100 to embed the game data 1208 in a television broadcast, to receive game commands 1204 from individual players via the second communication interface 1212 from the game terminals 108 communicating with the radio system 1010, and to update 1206 the game data 1208 on the basis of the received game commands 1204.

The local game server may be implemented by means of the above-described arrangement 104. The local game server 104 includes the receiver 110 configured to receive a television broadcast, and the processing unit 112 configured to separate game data from the received television broadcast, and to process the game data. The local game server 104 may also include a display interface 1230 configured to communicate display information on the game to a display 1214. The local game server 104 also includes a communication interface 114 configured to communicate the game data wirelessly to the game terminal 108.

The game terminal 108 may be of the type explained above, i.e. a terminal capable of communicating with the radio system 1010. The game terminal 108 includes game controls 1226 configured to issue game commands. The game terminal 108 also includes two communication interfaces: a first communication interface 1216 configured to receive game data wirelessly from the local game server 1216, and a second communication interface 1228 configured to communicate wirelessly with the radio system 1010. The game terminal 108 also includes a processing unit 1218 configured to process 1222 the received game data 1220 and the issued game commands 1224, and to transmit the issued game commands 1224 to the network game server 1200 via the second communication interface 1228. It is to be understood that game commands transferred from the game terminal 108 to the network game server 1200, besides the actual game commands issued by the player of the game by means of the game controls 1226, may also include game commands issued internally by the game software running in the processing unit 1218 of the game terminal 108. Such internal game commands may arise from the combined processing of the issued game commands and game data.

The game controls 1226 may be part of the normal user interface of the terminal 108 of a radio system 1010. A contemporary user interface includes buttons, a joystick, a trackball, a touch screen, acceleration sensor based sensing of movements of the terminal, just to name a few. The game controls 1226 may also be coupleable with the terminal 108: a miniature steering wheel, for example. The user interface and the controls may, however, also be implemented in other ways known in the art of user interface design.

The term ‘processing unit’ has been used in the various embodiments presented above. Such a processing unit may be implemented in ways known in the art of computers and terminals. Implementation techniques include: one or more processors depending on the necessary processing power, one or more application-specific integrated circuits (ASIC), one or more integrated circuits (IC), one or more electronic circuits. In the processor, software that implements part of the desired functionality may be run. A combination of these different implementation techniques may also be used: the terminal may include one or more ASIC's for processing the communication signals and further, one or more microprocessors for processing game data. Specialized processors, for example for processing game display data, may also be utilized. It is to be noted that this list of various implementation possibilities may not be exhaustive, but also other implementation techniques may be used.

Even though the invention has been described above with reference to an example according to the accompanying drawings, it is clear that the invention is not restricted thereto but can be modified in several ways within the scope of the appended claims.

1. An arrangement for transmitting data to a terminal of a radio system, the arrangement comprising:
a receiver configured to receive a television broadcast;
a processing unit configured to separate data from the received television broadcast; and
a transmitter configured to transmit the separated data through a wireless connection to the terminal.

2. The arrangement of claim 1, wherein the processing unit is further configured to convert the separated data into a format suitable for the terminal.

3. The arrangement of claim 1, wherein the separated data comprises at least one of the following: an application, a game, a part of a game, a wallpaper for a display, an upgrade to software, an application for participating in a television show or competition, a picture, a message, a command.

4. The arrangement of claim 1, wherein the receiver is integrated into a television set, and the processing unit and the transmitter are integrated into the television set or into a separate box coupleable to the television set.

5. The arrangement of claim 1, wherein the arrangement is integrated into a separate box coupleable to a Wireless Local Area Network (WLAN) access point.

6. The arrangement of claim 1, wherein the arrangement is integrated into a Digital Video Broadcasting Handheld (DVB-H) receiver.

7. The arrangement of claim 1, wherein the data is embedded in a digital television transmission or analogue television transmission.

8. The arrangement of claim 1, wherein the data is embedded in a text television transmission.

9. The arrangement of claim 1, wherein the arrangement further comprises a game server configured to run a game, and a display interface configured to communicate display information on the game to a display.

10. The arrangement of claim 9, wherein the arrangement further comprises a game control receiver configured to receive game commands from the terminal.

11. The arrangement of claim 1, wherein the wireless connection comprises at least one of the following: a wireless radio connection, an infrared connection.

12. The arrangement of claim 1, wherein for separating data, the processing unit is further configured to capture a screen shot from the received television broadcast.

13. The arrangement of claim 1, wherein the separated data comprises encrypted data, and the processing unit is further configured to decrypt the separated data.

14. An arrangement for transmitting data to a terminal of a radio system, the arrangement comprising:
receiving means for receiving a television broadcast;
processing means for separating data from the received television broadcast; and
transmitting means for transmitting the separated data wirelessly to the terminal.

15. The arrangement of claim 14, wherein the processing means convert the separated data into a format suitable for the terminal.

16. The arrangement of claim 14, wherein the arrangement further comprises game server means for running a game, and display interface means for communicating display information on the game to a display.

17. The arrangement of claim 16, wherein the arrangement further comprises game control receiving means for receiving game commands from the terminal.

18. The arrangement of claim 14, wherein for separating data, the processing means capture a screen shot from the received television broadcast.

19. The arrangement of claim 14, wherein the separated data comprises encrypted data, and the processing means decrypt the separated data.

20. A method for transmitting data to a terminal of a radio system, the method comprising:
embedding data in a television broadcast;
transferring the television broadcast to a receiver;
separating data from the received television broadcast by the receiver; and
transferring the separated data wirelessly from the receiver to a terminal.

21. The method of claim 20, wherein the method further comprises: converting the separated data into a format suitable for the terminal.

22. The method of claim 20, wherein the method further comprises: running a game in the terminal; and inputting the separated data as input to the game.

23. The method of claim 20, wherein for separating data, the method further comprises: capturing a screen shot from the received television broadcast.

24. The method of claim 20, wherein the separated data comprises encrypted data, and the method further comprises: decrypting the separated data.

25. A method for providing interactive television, the method comprising:
processing data in a network server;
embedding the data in a television broadcast;
receiving the television broadcast in a receiver;
separating data from the received television broadcast in the receiver;
transmitting the data wirelessly from the receiver to a terminal;
issuing response data by the terminal;
transmitting the response data from the terminal to the network server through a radio system; and
processing the response data in the network server.

26. An interactive television system comprising:
a network server, including a processing unit configured to process data, and to embed the data in a television broadcast;
a receiver configured to receive the television broadcast;
a second processing unit configured to separate data from the received television broadcast;
a transmitter configured to transmit the data wirelessly to a terminal;
a terminal including a second receiver configured to receive the data, a user interface configured to issue response data, and a transmitter configured to transmit the response data to the network server through a radio system;
wherein the processing unit of the network server is further configured to process the response data.

27. A method for running a network game, the method comprising:
processing game data in a network game server;
embedding game data in a television broadcast;
receiving the television broadcast in a local game server;
separating the game data from the received television broadcast in the local game server;
transmitting the game data wirelessly from the local game server to a game terminal;
issuing game commands by the game terminal;
transmitting game commands from the game terminal to the network game server through a radio system; and
updating the game data on the basis of the received game commands in the network game server.

28. A network game server comprising:
a processing unit configured to process game data;
a first communication interface configured to communicate with a television broadcast system;
a second communication interface configured to communicate with a radio system;
wherein the processing unit is further configured to transmit game data via the first communication interface to the television broadcast system to embed the game data in a television broadcast, to receive game commands from individual players via the second communication interface from game terminals communicating with the radio system, and to update the game data on the basis of the received game commands.

29. A local game server comprising:
a receiver configured to receive a television broadcast;
a processing unit configured to separate game data from the received television broadcast, and to process the game data; and
a display interface configured to communicate display information on the game to a display;
a communication interface configured to communicate the game data wirelessly to a game terminal.

30. A game terminal comprising:
game controls configured to issue game commands;
a first communication interface configured to receive game data wirelessly from a local game server;
a second communication interface configured to communicate wirelessly with a radio system; and
a processing unit configured to process the received game data and the issued game commands, and to transmit the issued game commands to a network game server via the second communication interface.
